(19) United States
(12) Patent Application Publication
(10) Pub. No.: US 2023/0226760 A1
(43) Pub. Date: Jul. 20, 2023

(54) MICRO-NANO 3D PRINTING DEVICE WITH MULTI-NOZZLES JET DEPOSITION DRIVEN BY ELECTRIC FIELD OF SINGLE FLAT PLATE ELECTRODE

(71) Applicants: QINGDAO UNIVERSITY OF TECHNOLOGY, Qingdao, Shandong (CN); QINGDAO 5D INTELLIGENT ADDITIVE MANUFACTURING TECHNOLOGY CO., LTD., Qingdao, Shandong (CN)

(72) Inventors: Hongbo LAN, Qingdao (CN); Guangming ZHANG, Qingdao (CN); Xiaoyang ZHU, Qingdao (CN); Jiankang HE, Qingdao (CN); Dichen LI, Qingdao (CN); Quan XU, Qingdao (CN); Jiawei ZHAO, Qingdao (CN)

(73) Assignees: QINGDAO UNIVERSITY OF TECHNOLOGY, Qingdao, Shandong (CN); QINGDAO 5D INTELLIGENT ADDITIVE MANUFACTURING TECHNOLOGY CO., LTD., Qingdao, Shandong (CN)

(21) Appl. No.: 17/636,780

(22) PCT Filed: Feb. 2, 2021
(86) PCT No.: PCT/CN2021/074878

§ 371 Date: Feb. 18, 2022

(30) Foreign Application Priority Data
Jan. 20, 2021 (CN) 2021100759816

(51) Int. Cl. B29C 64/209; B29C 64/106

(52) U.S. Cl. CPC B29C 64/209; B29C 64/106; B33Y 10/00

(57) ABSTRACT

A micro-nano 3D printing device with multi-nozzles jet deposition driven by electric field of single flat plate electrode, including: a printing head module group, printing nozzle module group of any material, printing substrate of any material, flat plate electrode, printing platform, signal generator, high-voltage power supply, feeding module group, precision back pressure control module group, XYZ three-axis precision motion platform, positive pressure air circuit system, observation and positioning module, UV curing module, laser rangefinder, base, connection frame, first adjustable bracket, second adjustable bracket, and a third adjustable bracket; the device realizes high throughput micro-nano 3D printing of jet deposition, including different configuration implementation schemes like multi-materials with multi-nozzles, single material with multi-nozzles and single material with multi-nozzles array, improves the printing efficiency, and realizes multi-materials macro/micro/nano printing, high-aspect-ratio microstructure efficient manufacturing, simultaneous printing of heterogeneous materials, efficient manufacturing of large area micro-nano array structure and parallel manufacturing of 3D printing.

### TECHNICAL FIELD

The present disclosure relates to the technical field of 3D printing and micro-nano manufacturing, and in particular to a micro-nano 3D printing device with multi-nozzles jet deposition driven by electric field of single flat plate electrode.

### BACKGROUND

Information of the related art part is merely disclosed to increase the understanding of the overall background of the present invention, but is not necessarily regarded as acknowledging or suggesting, in any form, that the information constitutes the prior art known to a person of ordinary skill in the art.

Micro-nano scale 3D printing is a novel processing technology for preparing micro-nano structures or functional products containing micro-nano featured structures based on additive manufacturing principles. Compared with existing micro-nano manufacturing technologies, the micro-nano 3D printing has the advantages of low production cost, simple process, wide variety of available printing materials and suitable substrates, no need for masks or molds, direct forming, process flexibility and adaptability, especially it has very outstanding advantages and wide industrial application prospects in complex 3D micro-nano structures, large aspect ratio micro-nano structures and composite (multi-material) material micro-nano structures as well as macro and micro multi-scale structure fabrication, non-flat substrate/flexible substrate/surface and micro-nano patterning of 3D surfaces. The micro-nano 3D printing has been applied in many fields such as microelectronics, optoelectronics, flexible electronics, high-definition flexible display, biomedical, tissue engineering, new materials, new energy, aerospace, and wearable devices. The micro-nano scale 3D printing has been listed by MIT's Technology Review as one of the top 10 disruptive emerging technologies in 2014.

After nearly a decade of development, more than ten micro-nano-scale 3D printing processes have been proposed, mainly including: micro-stereolithography, two-photon polymerization 3D laser direct writing, electro-hydrodynamic jet printing (electrojet printing), aerosol jet printing, micro-laser sintering, electrochemical deposition, micro-3D printing (binder jetting), and composite micro-nano 3D printing. Compared with other existing micro-nano 3D printing technologies, electrohydrodynamic jet printing (Electrohydrodynamic Jet Printing, EHD jet printing), electric field-driven jet micro-nano 3D printing technology in resolution, printing materials, equipment costs, macro/micro cross-scale 3D printing and other aspects emerge and witness rapid development, boast outstanding advantages, and have shown broad industrial application prospects in many fields such as optoelectronics, flexible electronics, tissue engineering, flexible display, new materials, new energy, aerospace. However, the biggest challenging problem facing them at present is the low production efficiency and many functional limitations due to the use of a single printing nozzle, which cannot meet the requirements of practical engineering applications.

However, the inventors find that these existing techniques are difficult to achieve micro-nano 3D printing with multi-nozzles, mainly due to:

(1) Both EHD jet printing and micro-nano 3D printing of electric field-driven jet suffer from severe electric field crosstalk between multiple nozzles, which affect each other and cannot achieve stable and consistent high-resolution printing. These existing technologies are directly connected to the high-voltage power supply due to conductive printing nozzles, and each printing nozzle jet/droplet material carries an electrical charge during the printing process with the same polarity (positive or negative charge), and there is a serious electric field crosstalk, Coulomb repulsion forces problem between the jet/droplet generated by adjacent printing nozzles, resulting in multi-nozzles unable to achieve stable and consistent printing. Therefore, these existing technologies are difficult to achieve parallel high-resolution printing with multi-nozzles from the principle.

(2) These existing technologies require the conductive printing nozzle to be directly connected to the high-voltage power supply or connected to the high-voltage power supply through the extraction electrode because the printing nozzle is one of the electrodes (some improved EHD jet printing/electric field-driven jet micro-nano 3D printing uses the extraction electrode as one of the electrodes). As a result, this structural form leads to difficulties in achieving a high-density array arrangement of multi-nozzles (with mechanical interference), which leads to a limited number of integrated printing nozzles on the one hand, and in particular can make the overall printing nozzle size large and the practical application is greatly limited, especially for micro-nano scale high-precision printing. Therefore, the existing technology due to the mechanical interference between multiple nozzles also leads to difficulties in achieving micro-nano scale multi jet printing.

(3) Sub-micro scale and nano scale 3D printing nozzles are difficult to manufacture, and the actual service life of the nozzle after gold spraying treatment is short, resulting in high production cost and long production cycle; for sub-micro scale and nano scale 3D printing, glass nozzles or silicon-based nozzles are generally used. These materials are non-conductive, and these non-conductive nozzles must be electrically conductive before they can be used, such as gold spraying. In addition, when the nozzle size is less than 100 nm, on the one hand, it is difficult to conduct conductive treatment on the nozzle (the nozzle size is too small, the nozzle size changes, and blockage is easy to occur), on the other hand, the service life of the conductive treated nozzle is very short due to the very thin conductive layer.

(4) Multi-nozzles array brings great difficulties for both mechanical system design and multi-nozzles electrical control. Therefore, it is difficult for E-jet printing and electric field driven jet micro-nano 3D printing to realize multi-nozzles printing, whether from the forming principle or its specific implementation. Therefore, the existing commercial E-jet printing devices and electric field driven jet micro-nano 3D printing adopt single nozzle, which greatly limits their wide application in the engineering field, and has become the biggest technical bottleneck of electrojet printing and electric field driven jet micro-nano 3D printing.

### SUMMARY

To address the shortcomings of the prior art, the present disclosure provides a micro-nano 3D printing device with multi-nozzles jet deposition driven by electric field of single flat plate electrode, which realizes multi-nozzles parallel micro-nano 3D printing, the device includes different configuration realization schemes such as multi-material multi-nozzles, single material multi-nozzles, and single material multi-nozzles array, which greatly improves the printing efficiency, realizes multi-material macro/micro/nano multi-scale printing, high-aspect-ratio structure efficient manufacturing, heterogeneous material simultaneous printing, large area micro-nano array structure efficient manufacturing and 3D printing parallel efficient manufacturing, and has unique advantages of simple structure, low production cost, good universality (suitable for any material printing nozzle, any material print material, any material substrate), and stable printing with any combination of printing nozzle (conductive and non-conductive), substrate (conductive and non-conductive) and print material (conductive and non-conductive); in particular, it also has the function of arbitrary arrangement of printing nozzle modules (linear, triangular, rhombic, etc.); breaks through the technical bottleneck that the existing micro-nano 3D printing based on nozzle jet/extrusion cannot realize multi-nozzles parallel micro-nano 3D printing.

In order to achieve the above purpose, the present disclosure adopts the following technical solution.

A micro-nano 3D printing device with multi-nozzles jet deposition driven by electric field of single flat plate electrode, comprising: a printing head module group, a printing nozzle module group of any material, a printing substrate of any material, a flat plate electrode, a printing platform, a signal generator, a high-voltage power supply, a feeding module group, a precision back pressure control module group, an XYZ three-axis precision motion platform, a positive pressure air circuit system, an observation and positioning module, a UV curing module, a laser rangefinder, a base, a connection frame, a first adjustable bracket, a second adjustable bracket, and a third adjustable bracket;

the printing platform is fixed on the base, the flat plate electrode is located on top of the printing platform, an output terminal of the signal generator is connected to the high-voltage power supply, a first end of the high-voltage power supply is connected to the flat plate electrode and a second end is grounded; the printing substrate is located on top of the flat plate electrode, each printing nozzle in the printing nozzle module group is connected to a lowermost outlet of the corresponding printing head in the printing head module group and is located directly above the flat plate electrode, and each the printing nozzle in the printing nozzle module group is perpendicular to the flat plate electrode;

each feeding module in the feeding module group is connected to the lower half of the corresponding printing head in the printing head module group, the back pressure control module in the precision back pressure control module group is connected to the top of the corresponding printing head in the printing head module group, and the positive pressure air circuit system is connected to each the back pressure control module in the precision back pressure control module group;

the printing head module group is connected to the XYZ three-axis precision motion platform through the connection frame, the observation and positioning module is connected to the first adjustable bracket, and the first adjustable bracket is fixedly connected to the connection frame; the laser rangefinder is connected to the second adjustable bracket, and the second adjustable bracket is fixedly connected to the connection frame; the UV curing module is connected to the third adjustable bracket, and the third adjustable bracket is fixedly connected to the connection frame.

As some possible implementations, the number of the printing heads in the printing head module group, the number of the printing nozzles in the printing nozzle module group, the number of the feeding modules in the feeding module group and the number of the back pressure control modules in the precision back pressure control module group are the same, and the number is at least two, all settings are one-to-one correspondence.

As some possible implementations, the printing head module group has one printing head, at least two material outlets are provided at the bottom of the printing head, each the material outlet is connected to the printing nozzle in the printing nozzle module group, and the printing nozzle module group has at least two printing nozzles, the number of the feeding modules in the feeding module group is one, and the number of the back pressure control modules in the precision back pressure control module group is one.

As some possible implementations, the printing heads and/or printing nozzles are arranged in a triangular array.

As some possible implementations, the printing heads and/or printing nozzles are arranged in a linear array.

As some possible implementations, the printing heads and/or printing nozzles are arranged in a rhombic array.

As some possible implementations, the printing heads and/or printing nozzles are arranged in a planar array.

As some possible implementations, the printing heads and/or printing nozzles are arranged in a circular array.

As some possible implementations, the observation and positioning module is located on a first side of the printing head, and the UV curing module and the laser rangefinder are both located on a second side of the printing head.

As some possible implementations, the printing nozzles in the printing nozzle module group are any one of conductive and non-conductive materials or a combination of several materials.

As some possible implementations, the printing nozzle in the printing nozzle module group is a stainless steel nozzle, a MUSASHI nozzle, a glass nozzle or a silicon nozzle.

As some possible implementations, range of an inner diameter size of the printing nozzle in the printing nozzle module group is 0.1 μm˜300 μm.

As some possible implementations, the printing substrate is any one or a combination of any one or more of conductors, semiconductors, and insulators.

As some possible implementations, the printing substrate is PET, PEN, PDMS, glass, silicon or copper plate.

As some possible implementations, the flat plate electrode is any one or a combination of copper electrode, aluminum electrode, steel electrode and composite conductive material.

As some possible implementations, a thickness range of the flat plate electrode is 0.5 mm˜30 mm.

As some possible implementations, a flatness of the flat plate electrode is greater than or equal to tolerance class 5 accuracy.

As some possible implementations, the XYZ three-axis precision motion platform is a gantry type structure with linear motor drive.

As some possible implementations, the XYZ three-axis precision motion platform adopts a three-axis air floatation motion platform.

As some possible implementations, the XYZ three-axis precision motion platform adopts a three-axis gantry linear motion platform.

As some possible implementations, an effective stroke range of X and Y axes of the XYZ three-axis precision motion platform is 0 mm˜600 mm, and a repeated positioning accuracy is greater than or equal to ±0.4 μm, a positioning accuracy is greater than or equal to ±0.6 μm, a maximum speed is 1000 mm/s, a maximum acceleration is greater than or equal to 1 g, the effective stroke range of Z axis is 0 mm˜300 mm, and the positioning accuracy is greater than or equal to ±0.1 μm.

As some possible implementations, the high-voltage power supply capable of setting bias voltage can output DC high-voltage, AC high-voltage or pulse high-voltage, and a range of the set bias voltage is 0 KV˜2 KV and continuously adjustable;

a range of the DC high-voltage is 0 KV˜5 KV, a range of the output pulse DC voltage is 0 KV˜±4 KV and continuously adjustable, a range of the output pulse frequency is 0 Hz˜3000 Hz and continuously adjustable, and a range of the AC high-voltage is 0 KV˜±4 KV.

As some possible implementations, the feeding module is a precision syringe pump or a suck-back electric screw device or a barrel already containing a precision extrusion device.

As some possible implementations, the printing platform has both insulation and heating functions with a maximum heating temperature of 200° C.

As some possible implementations, a pressure range of the positive pressure air circuit system is 0 bar˜4 bar, and a pressure regulation accuracy of the back pressure control module is greater than or equal to 1 kPa.

As some possible implementations, the signal generator is able to output a variety of waveforms, an output frequency is 0 MHz˜1 MHz, and is able to adjust the output peak voltage, bias voltage, frequency and duty cycle to achieve dot or line printing as needed.

As some possible implementations, the observation module includes one or both of an oblique observation camera and/or a vertical observation camera.

As some possible implementations, the observation module uses an industrial camera or a high-resolution CCD camera.

As some possible implementations, the UV curing module is a UV LED or a high-pressure mercury lamp.

As some possible implementations, the laser rangefinder measures the distance of transparent or non-transparent materials.

Compared with the prior art, the beneficial effects of the present disclosure are:

(1) The micro-nano 3D printing technology with multi-nozzles jet deposition driven by electric field of single flat plate electrode provided by the present disclosure is a novel technology to realize high throughput micro-nano 3D printing with multi-nozzles jet deposition driven by electric field by combining the advantages of electric field of single flat plate electrode driving jet and multi-printing head (multi-nozzles) array, which only needs to connect the plate electrode with the positive electrode (negative electrode) of high-voltage power supply, multiple printing heads (or multiple printing nozzles) array are arranged directly above the flat plate electrode. The multiple printing heads (or multiple printing nozzles) no longer need to connect multiple electrodes or grounded counter electrodes, which overcomes the problem of electric field crosstalk (electric field interference between multiple nozzles/spray group electrodes) existing in the existing E-jet printing or the micro-nano 3D printing of electric field driven jet. It is suitable for nozzles of any material, printing substrates of any material and type, and any printing materials. It can realize high-efficiency micro-nano 3D printing with multi-nozzles jet deposition driven by electric field, greatly simplify the electrode, have simple structure, low cost, good process universality and scalability, and have almost no restrictions on the application field.

(2) The micro-nano 3D printing device with multi-nozzles jet deposition driven by electric field of single flat plate electrode provided by the present disclosure has no problems such as electric field crosstalk and Coulomb repulsion forces. Therefore, on the one hand, it can realize multi-nozzles parallel high-resolution printing; on the other hand, it also improves the printing accuracy and stability. Since the nozzle of the present disclosure has no connection with the high-voltage power supply, the stable conical jet injection is realized by relying on the induced charge. Although the charge of the jet/droplet is redistributed due to the polarization of the electric field, it is electrically neutral as a whole, avoiding the problems such as the electric field crosstalk and Coulomb repulsion force that cannot be avoided due to the limitation of the printing principle of the existing current volume dynamic jet printing and electric field driven jet micro-nano 3D printing.

(3) The micro-nano 3D printing device with multi-nozzles jet deposition driven by electric field of single flat plate electrode provided by the present disclosure has no constraints and restrictions in terms of mechanical structure or electrical control, is convenient to realize micro-nano 3D printing with multi-nozzles jet deposition, and has very high design flexibility and flexibility, and expands the application field and scope.

(4) The micro-nano 3D printing device with multi-nozzles jet deposition driven by electric field of single flat plate electrode provided by the present disclosure can realize an efficient, multifunctional and high-resolution 3D printing of a variety of materials of multi-nozzles array; realize efficient large area macro/micro/nano multi-scale 3D printing with multi-nozzles array of the same material; also realize a high-efficiency micro-nano 3D printing of single nozzle and multi-nozzles array of the same material. The disclosed technology can realize the micro-nano 3D printing with multi-nozzles with different needs to meet the actual needs of different users.

(5) The micro-nano 3D printing device with multi-nozzles jet deposition driven by electric field of single flat plate electrode provided by the present disclosure has almost no limit on the number of printing heads (nozzles) in theory, and multiple printing heads (nozzles) can be arranged in a variety of different arrangement schemes such as plane array or ring array. In addition, the multiple printing heads (printing nozzles) have the outstanding advantages of compact structure and high-density arrangement of multiple printing heads (printing nozzles).

(6) The micro-nano 3D printing device with multi-nozzles jet deposition driven by electric field of single flat plate electrode provided by the present disclosure realizes a diversity of printing materials, can print a variety of materials at the same time, and realizes the manufacture of new structures, new devices and new functional products.

(7) The micro-nano 3D printing device with multi-nozzles jet deposition driven by electric field of single flat plate electrode provided by the present disclosure breaks through the limitations and constraints of nozzles, substrates and printing materials, and realizes high-resolution and stable printing of any combination of nozzles (conductive and non-conductive), substrates (conductive and non-conductive) and printing materials (conductive and non-conductive).

(8) The micro-nano 3D printing device with multi-nozzles jet deposition driven by electric field of single flat plate electrode provided by the present disclosure realizes the high-resolution, stable and efficient printing of conductive materials on the conductive substrates. The nozzles do not directly apply high-voltage, but through electrostatic induction, the problem that the stable and continuous printing cannot be realized due to the phenomena of short circuit and discharge breakdown in the printing of conductive materials by traditional EFI printing is overcome.

(9) The micro-nano 3D printing device with multi-nozzles jet deposition driven by electric field of single flat plate electrode provided by the present disclosure realizes high-resolution and efficient printing of biomaterials or biological cells, expands the range of printing materials, and can better ensure their biological activity, especially for biomaterials and biological cells that are not allowed to directly apply high-voltage.

(10) The micro-nano 3D printing device with multi-nozzles jet deposition driven by electric field of single flat plate electrode provided by the present disclosure solves the manufacturing difficulties of sub-micro-scale and nano-scale 3D printing nozzles, reduces the production cost of nozzles, and improves the service life of nozzles. Glass nozzles or silicon-based nozzles widely used in sub-micro-scale and nano-scale 3D printing can be used without conductive treatment.

(11) The micro-nano 3D printing device with multi-nozzles jet deposition driven by electric field of single flat plate electrode provided by the present disclosure has the unique advantages of simple structure, low cost, high printing efficiency, good stability and universality.

(12) The micro-nano 3D printing device with multi-nozzles jet deposition driven by electric field of single flat plate electrode provided by the present disclosure can realize multi-material macro/micro/nano structure cross-scale manufacturing, especially multi-material macro/micro/nano structure cross-scale integrated manufacturing, which greatly expands the function of the micro-nano 3D printing with electric field driven jet deposition.

(13) The micro-nano 3D printing device with multi-nozzles jet deposition driven by electric field of single flat plate electrode provided by the present disclosure improves the accuracy, stability, consistency and printing efficiency of 3D printing, expands the range of printing materials, and can truly realize high-precision micro-nano scale 3D printing.

(14) The micro-nano 3D printing device with multi-nozzles jet deposition driven by electric field of single flat plate electrode provided by the present disclosure introduces an observation module to observe and monitor the whole printing process in real time, and solve the accurate positioning of the nozzle in the multi-layer printing process.

(15) The micro-nano 3D printing device with multi-nozzles jet deposition driven by electric field of single flat plate electrode provided by the present disclosure adopts a new feeding method and device, which can realize the continuous and stable feeding of trace liquid and ensure the stability in the printing process, overcomes the problems existing in the traditional feeding mode of E-jet printing (the back pressure and feeding are unstable in the printing process, which cannot realize high-precision printing, especially the poor stability in the printing process, which seriously affects the consistency and high precision of printed graphics).

(16) The micro-nano 3D printing device with multi-nozzles jet deposition driven by electric field of single flat plate electrode provided by the present disclosure realizes the parallel manufacturing of micro-nano 3D printing, and realizes the manufacturing of heterogeneous materials and 3D structure integration.

(17) The micro-nano 3D printing technology with multi-nozzles jet deposition driven by electric field of single flat plate electrode provided by the present disclosure can be used in aerospace, micro-nano electromechanical systems, biomedicine, tissues and organs, new materials (lattice materials, metamaterials, functional gradient materials, composites, etc.), 3D functional structure electronics, wearable devices, new energy (fuel cells, solar energy, etc.), high definition display, microfluidic devices, micro-nano optical devices, micro-nano sensors, printing electronics, stretchable electronics, software robots and many other fields and industries.

(18) The micro-nano 3D printing device with multi-nozzles jet deposition driven by electric field of single flat plate electrode provided by the present disclosure solves the problems existing in the existing micro-nano 3D printing with electric field driven jet deposition (only a single printing head (nozzle) can be used, resulting in the bottleneck problem of low printing efficiency and limited function, and it is impossible to realize multi-nozzles array printing), and provides a new industrial solution that can realize efficient multi-heads (multi-nozzles) array multi-material multi-scale micro-nano 3D printing.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of the basic principles of a micro-nano 3D printing device with multi-nozzles jet deposition driven by electric field of single flat plate electrode provided in the present disclosure.

FIG. 2 is a schematic diagram of a structure of the micro-nano 3D printing device with multi-nozzles driven by electric field provided in Embodiment 1 of the present disclosure.

FIG. 3 is a schematic diagram of the structure of the micro-nano 3D printing device with multi-nozzles driven by electric field provided in Embodiment 2 of the present disclosure.

FIG. 4 is a schematic diagram of the structure of the micro-nano 3D printing device with multi-nozzles driven by electric field provided in Embodiment 3 of the present disclosure.

1, high-voltage power supply; 2, signal generator; 3, XYZ three-axis precision motion platform (301, Y-axis precision motion platform; 302, X-axis precision motion platform; 303, Z-axis precision motion platform); 4, positive pressure air circuit system; 5, precision back pressure control module; 6, observation and positioning module; 7, first adjustable support; 8, feeding module group (1-N); 9, printing head module group (1-N); 10. printing nozzle module group (1-N, any material); 11, laser rangefinder; 12, second adjustable bracket; 13, UV curing module; 14, third adjustable bracket; 15, connecting frame; 16, printing substrate (any material); 17, flat plate electrode; 18, printing platform; 19, base.

### DETAILED DESCRIPTION

The present disclosure will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present disclosure. As used herein, the singular form is also intended to include the plural form unless the context clearly dictates otherwise. In addition, it should further be understood that, terms “comprise” and/or “include” used in this specification indicate that there are features, steps, operations, devices, components, and/or combinations thereof.

The embodiments and features of the embodiments in this disclosure may be combined with each other without conflict.

### EXAMPLE 1

In order to overcome the shortcomings and limitations of the existing micro-nano 3D printing technology, it is urgent to develop a micro-nano 3D printing technology with multi-nozzles of electric field driven jet to realize a high-efficiency micro-nano 3D printing and a multi-material cross-scale 3D printing, meet the requirements of industrial micro-nano 3D printing, and break through the core bottleneck of the current micro-nano 3D printing of electric field driven jet.

An embodiment 1 of the present disclosure provides a micro-nano 3D printing device with multi-nozzles jet deposition driven by electric field of single flat plate electrode, as shown in FIG. 1, a basic principle thereof is:

The flat plate electrode is connected to a positive (or negative) electrode of the high-voltage pulse power supply without the need for a grounded counter electrode, especially since both the printing nozzle module group and the substrate no longer serve as electrodes (pairs), breaking through the constraints and limitations of conventional electrojet printing and existing electric field-driven jet deposition micro-nano 3D printing for conductivities of the printing nozzle module group and the substrate. A stable printing can be achieved even with insulated printing nozzle module group and insulated substrates. It uses electrostatic induction to self-excite (induce) the required electric field for jetting, and FIG. 1(b) is a schematic of the basic print-forming principle.

The positive pole of the high-voltage pulse power supply is connected to the flat plate electrode, so that it has a high potential, according to the contact electrification principle, at this time the flat plate electrode will be uniformly arranged on the positive charge, the direction of the electric field formed from the flat plate electrode pointing to infinity. Due to the role of electrostatic induction, the object in the electric field is polarized, under the action of the electric field generated by the flat plate electrode, the charge on the surface and inside of the printing substrate migrates, charge redistribution to form an electric moment, the positive charge distribution on the upper surface, and the negative charge distribution in the lower surface.

The extruded printing material in a shape of curved liquid surface at the printing nozzle module group is also polarized under the action of electric field, and a negative charge is distributed on the outer surface of the curved liquid surface. The liquid (melt) at the printing nozzle module group is stretched to form a Taylor cone under the action of the electric field, and as the applied voltage increases, a stable cone jet appears (the jet/droplet sprayed by the nozzle is electrically neutral as a whole) and the printing material is jetted and deposited onto the substrate. When a negative high-voltage is applied to the flat plate electrode, a charge opposite to the high-voltage applied to the positive electrode is distributed inside and on the surface of the nozzle (molten) droplet, and the formed electric field will still drive the printing material to jet and deposit on the substrate or the formed structure.

The micro-nano 3D printing based on electric field of single flat plate electrode driven jet deposition adopted in the present embodiment is a new technology based on self-excited electrostatic induction electric field driven micro jet forming, connecting the flat plate electrode to the positive (or negative) electrode of the high-voltage power supply without the need for a grounded counter electrode, especially since both the printing nozzles and the substrate no longer act as electrodes (pairs). This aspect breaks through the existing technology for the constraints and limitations of the conductivity of the printing nozzle and substrate; in particular, the printing nozzle and high-voltage power supply without any connection, relying on polarized charge to achieve a stable cone jet, the jet/droplet from the printing nozzle despite the existence of charge redistribution due to electric field polarization, but the jet/droplet overall is electrically neutral, no electric field crosstalk and Coulomb repulsive force problem between multiple printing heads. Solved the problems in the prior art that due to the direct connection between the conductive nozzle and the high-voltage power supply, the jet/droplet material carries the same polarity charge in the printing process, there is serious electric field crosstalk and Coulomb repulsion, and the stability and consistent printing of multiple nozzles cannot be realized. Therefore, the present invention uses a new micro-nano 3D printing forming principle, which in turn enables parallel micro-nano 3D printing with multiple printing nozzles.

Based on the above basic principles, the present disclosure provides a micro-nano 3D printing device with multi-nozzles jet deposition driven by electric field of single flat plate electrode, including a high-voltage power supply 1, a signal generator 2, an XYZ three-axis precision motion platform 3 (Y-axis precision displacement stage 301, X-axis precision displacement stage 302, Z-axis precision displacement stage 303), a positive pressure air circuit system 4, a precision back pressure control module group 5, an observation and positioning module 6, a first adjustable bracket 7, a feeding module (1-N) 8, a printing head module group (1-N) 9, a printing nozzle module group (1-N, any material) 10, a laser rangefinder 11, a second adjustable bracket 12, a UV curing module 13, a third adjustable bracket 14, a connection frame 15, a printing substrate (any material) 16, a flat plate electrode 17, a printing platform 18, and a base 19.

Specifically, the base 19 is placed at a lowermost part of the device; the printing platform 18 is fixed on the base 19; the flat plate electrode 17 is placed on a top of the printing platform 18; the high-voltage power supply 1 (positive or negative) connected to the signal generator 2 is connected to the flat plate electrode 17 at a first end and grounded at a second end.

The printing substrate 16 is placed on a top of the flat plate electrode 17; the printing nozzle module group (1-N, any material) 10 is connected to an outlet at the lowest end of the printing head module group (1-N) 9 and placed directly above the flat plate electrode 17, and the printing nozzle module group (1-N, any material) 10 is perpendicular to the flat plate electrode 17.

The feeding module (1-N) 8 is connected to a lower half of the printing head module group (1-N) 9.

The precision back pressure control module group 5 is connected to a top of printing head module group (1-N) 9; the positive pressure air circuit system 4 is connected to the precision back pressure control module group 5; the printing head module group (1-N) 9 is connected to the XYZ three-axis precision motion platform 3 via the connection frame 15.

The observation and positioning module 6 is placed on the first adjustable bracket 7 fixed to the connecting frame 15; the laser rangefinder 11 is placed on the second adjustable bracket 12 fixed to the connecting frame 15; the UV curing module 13 is placed on the third adjustable bracket 14 fixed to the connecting frame 15.

The number of printing nozzles included in the printing nozzle module group: 1, 2, 3, . . . , N, and the number of printing nozzles is at least not less than 2; the number of feeding modules included in the feeding module group: 1, 2, 3, . . . , N; the number of precision back pressure control modules included in the precision back pressure control module group: 1, 2, 3, . . . , N. Depending on the actual needs and required functions, the number and combined configuration of the printing head module group, the printing nozzle module group, the feeding module group, and the precision back pressure control module group are selected in the following two options:

the first option: the printing head module group, the printing nozzle module group, the feeding module group, the precision back pressure control module group are one-to-one correspondence, and the number of the printing head, the printing nozzle, the feeding module, the precision back pressure control module is not less than 2;

the second option: the printing head in the printing head module group is one, and at least 2 or more outlets are set at a bottom of the printing heads, and these outlets are connected to the printing nozzles respectively; the number of the printing nozzle in the printing nozzle module group is not less than 2; the number of feeding module in the feeding module group is 1; the number of the precision back pressure control module in the precision back pressure control module group is 1.

### EXAMPLE 2

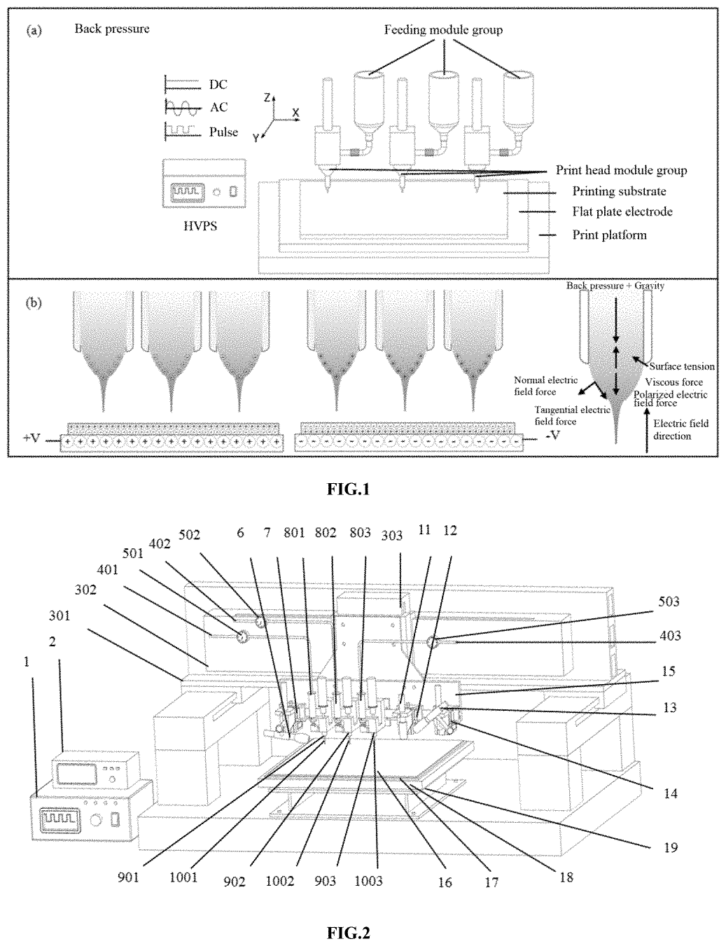

In order to realize simultaneous manufacturing of macro/micro/nano structures, efficient manufacturing of large-area array structures and manufacturing of large aspect ratio structures, the embodiment 2 of the present disclosure provides a micro-nano 3D printing device with single-material multi-nozzles jet deposition driven by electric field of single flat plate electrode. As shown in FIG. 2, three printing heads are arranged in a straight line, using the same material and nozzles with the same diameter, with an area of 250 mm×250 mm transparent electrode manufacturing.

Wherein:

the printing materials in the feeding module groups 801-803 are nano conductive silver paste;

the printing nozzles 1001-1003 are 30G stainless steel conductive nozzles (inner diameter of 150 μm);

the printing substrate is a 300 mm×300 mm×2 mm ordinary transparent glass;

the flat plate electrode is a 350 mm×350 mm×3 mm copper plate;

the high-voltage power supply 1 is set to an amplifier mode; the signal generator 2 is set with a frequency of 800 Hz, a peak value of 7V, a bias voltage of 0V and a duty cycle of 50%;

the precision back pressure control module 5 is set to 0.15 MPs;

a height of the nozzle port of the printing nozzle module group 10 from the printing substrate 16 is 0.15 mm;

when the XYZ three-axis precision motion platform 3 runs the printing program, a synthetic speed is set to 20 mm/s and acceleration is set to 100 mm/s².

### EXAMPLE 3

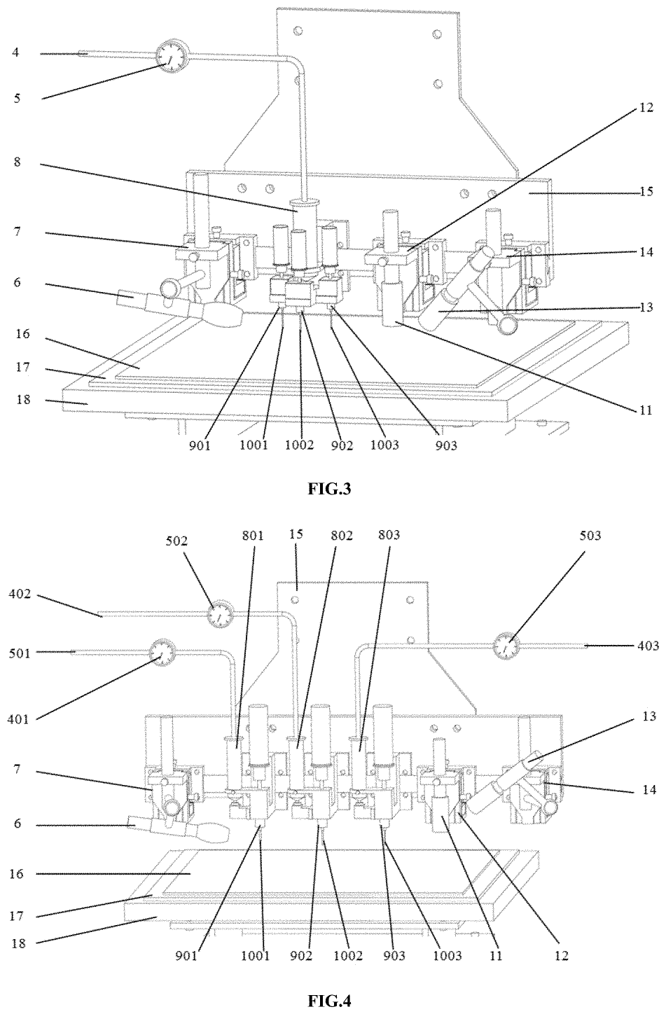

In order to realize efficient manufacturing of large-area array structures and large aspect ratio structures, the embodiment 3 of the present disclosure provides a micro-nano 3D printing device with single-barrel multi-nozzles jet deposition driven by electric field of single flat plate electrode, as shown in FIG. 3; the printing nozzles in the FIG.3 are distributed in a triangular array.

Wherein:

the printing material in the feeding module group 8 is a nano-conductive silver paste;

the printing nozzle module group 1001-1003 are 30G stainless steel conductive nozzles (inner diameter of 150 μm);

the printing substrate 16 is a 300 mm×300 mm×2 mm ordinary glass;

the flat plate electrode 17 is a 350 mm×350 mm×3 mm copper plate;

the high-voltage power supply 1 is set to an amplifier mode; the signal generator 2 is set with a frequency of 800 Hz, a peak value of 7V, a bias voltage of 0V and a duty cycle of 50%;

the precision back pressure control module 5 is set to 0.15 MPs;

a height of the nozzle port of the printing nozzle module group 10 from the printing substrate 16 is 0.15 mm;

when the XYZ three-axis precision motion platform 3 runs the printing program, a synthetic speed is set to 20 mm/s and acceleration is set to 100 mm/s².

### EXAMPLE 4

In order to realize multi-material macro-micro multi-scale manufacturing, the embodiment 4 of the present disclosure provides a micro-nano 3D printing device with multi-materials multi-nozzles jet deposition driven by electric field of single flat plate electrode, as shown in FIG. 4; in the manufacturing of flexible cross-scale hybrid circuits, different printing materials are placed in the feeding module group 8, and the material and size of each nozzle are completely different.

Wherein:

in the feeding module group 8, the printing material of the feeding modules 801-802 is nano conductive silver paste, and the printing material of the feeding module 803 is PDMS;

the printing nozzle module group 10 respectively selects glass insulated nozzles 1001-1002 (inner diameter of 50 μm) and a 27G stainless steel conductive nozzle 1003 (inner diameter of 200 μm);

the printing substrate is a 300 mm×300 mm×2 mm ordinary transparent glass;

the flat plate electrode is a 350 mm×350 mm×3 mm copper plate;

the high-voltage power supply 1 is set to an amplifier mode; the signal generator 2 is set with a frequency of 800 Hz, a peak value of 8V, a bias voltage of 0V and a duty cycle of 50%;

a control valve 501, a control valve 502, and a control valve 503 of the precision back pressure control module 5 are set to 0.15 MPa, 5 kPa and 0.13 MPa respectively;

a height of the nozzle port of the printing nozzles 1001-1002 from the printing substrate 16 is 0.1 mm; a height of the nozzle port of the printing nozzle 1003 from the printing substrate 16 is 0.25 mm;

when the XYZ three-axis precision motion platform 3 runs the printing program, a synthetic speed is set to 20 mm/s and acceleration is set to 100 mm/s².

The foregoing descriptions are merely preferred embodiments of the present invention, but not intended to limit the present invention. For those skilled in the art, the micro-nano 3D printing device of electric field of single flat plate electrode driven jet deposition also includes other combinations and configuration options. Any modification, equivalent replacement, or improvement made within the spirit and principle of the present invention shall fall within the protection scope of the present invention.

1. A micro-nano 3D printing device with multi-nozzles jet deposition driven by electric field of single flat plate electrode, comprising:
a printing head module group, a printing nozzle module group of any material, a printing substrate of any material, a flat plate electrode, a printing platform, a signal generator, a high-voltage power supply, a feeding module group, a precision back pressure control module group, an XYZ three-axis precision motion platform, a positive pressure air circuit system, an observation and positioning module, a UV curing module, a laser rangefinder, a base, a connection frame, a first adjustable bracket, a second adjustable bracket, and a third adjustable bracket; wherein,
the printing platform is fixed on the base, the flat plate electrode is located on top of the printing platform, an output terminal of the signal generator is connected to the high-voltage power supply, a first end of the high-voltage power supply is connected to the flat plate electrode and a second end of the high-voltage power supply is grounded; the printing substrate is located on top of the flat plate electrode, each printing nozzle in the printing nozzle module group is connected to a lowermost outlet of the corresponding printing head in the printing head module group and is located directly above the flat plate electrode, and each the printing nozzle in the printing nozzle module group is perpendicular to the flat plate electrode;
each feeding module in the feeding module group is connected to a lower half of the corresponding printing head in the printing head module group, the back pressure control module in the precision back pressure control module group is connected to a top of the corresponding printing head in the printing head module group, and the positive pressure air circuit system is connected to each the back pressure control module in the precision back pressure control module group; and
the printing head module group is connected to the XYZ three-axis precision motion platform through the connection frame, the observation and positioning module is connected to the first adjustable bracket, and the first adjustable bracket is fixedly connected to the connection frame; the laser rangefinder is connected to the second adjustable bracket, and the second adjustable bracket is fixedly connected to the connection frame; the UV curing module is connected to the third adjustable bracket, and the third adjustable bracket is fixedly connected to the connection frame.

2. The micro-nano 3D printing device according to claim 1, wherein:
a number of the printing heads in the printing head module group, a number of the printing nozzles in the printing nozzle module group, a number of the feeding modules in the feeding module group and a number of the back pressure control modules in the precision back pressure control module group are same, and the number is at least two, the printing heads, the printing nozzles, the feeding modules and the back pressure control modules are set in one-to-one correspondence.

3. The micro-nano 3D printing device according to claim 1, wherein:
the printing head module group has one printing head, at least two material outlets are provided at a bottom of the printing head, each the material outlet is connected to the printing nozzle in the printing nozzle module group, and the printing nozzle module group has at least two printing nozzles, the number of the feeding modules in the feeding module group is one, and the number of the back pressure control modules in the precision back pressure control module group is one.

4. The micro-nano 3D printing device according to claim 1, wherein:
the printing heads and/or printing nozzles are arranged in a triangular array; or,
the printing heads and/or printing nozzles are arranged in a linear array;
or,
the printing heads and/or printing nozzles are arranged in a rhombic array;
or,
the printing heads and/or printing nozzles are arranged in a planar array;
or,
the printing heads and/or printing nozzles are arranged in a circular array.

5. The micro-nano 3D printing device according to claim 1, wherein:
the observation and positioning module is located on a first side of the printing head, and the UV curing module and the laser rangefinder are both located on a second side of the printing head.

6. The micro-nano 3D printing device according to claim 1, wherein:
the printing nozzles in the printing nozzle module group are any one of conductive and non-conductive materials or a combination of several materials;
or,
the printing nozzle in the printing nozzle module group is a stainless steel nozzle, a MUSASHI nozzle, a glass nozzle or a silicon nozzle;
or,
a range of an inner diameter size of the printing nozzle in the printing nozzle module group is 0.1 μm˜300 μm;
or,
the printing substrate is any one or a combination of any one or more of conductors, semiconductors, and insulators;
or,
the printing substrate is PET, PEN, PDMS, glass, silicon or copper plate;
or,
the flat plate electrode is any one or a combination of copper electrode, aluminum electrode, steel electrode and composite conductive material;
or,
a thickness range of the flat plate electrode is 0.5 mm˜30 mm;
or,
a flatness of the flat plate electrode is greater than or equal to tolerance class 5 accuracy.

7. The micro-nano 3D printing device according to claim 1, wherein:
the XYZ three-axis precision motion platform is a gantry type structure with linear motor drive;
or,
the XYZ three-axis precision motion platform adopts a three-axis air floatation motion platform;
or,
the XYZ three-axis precision motion platform adopts a three-axis gantry linear motion platform;
or,
an effective stroke range of X and Y axes of the XYZ three-axis precision motion platform is 0 mm˜600 mm, and a repeated positioning accuracy is greater than or equal to ±0.4 μm, a positioning accuracy is greater than or equal to ±0.6 μm, a maximum speed is 1000 mm/s, a maximum acceleration is greater than or equal to 1 g, the effective stroke range of Z axis is 0 mm˜300 mm, and the positioning accuracy is greater than or equal to ±0.1 μm.

8. The micro-nano 3D printing device according to claim 1, wherein:
the high-voltage power supply capable of setting bias voltage can output DC high-voltage, AC high-voltage or pulse high-voltage, and a range of the set bias voltage is 0 KV˜2 KV and continuously adjustable;
a range of the DC high-voltage is 0 KV˜5 KV, a range of the output pulse DC voltage is 0 KV˜±4 KV and continuously adjustable, a range of the output pulse frequency is 0 Hz˜3000 Hz and continuously adjustable, and a range of the AC high-voltage is 0 KV˜±4 KV.

9. The micro-nano 3D printing device according to claim 1, wherein:
the feeding module is a precision syringe pump or a suck-back electric screw device or a barrel already containing a precision extrusion device;
or,
the printing platform has both insulation and heating functions with a maximum heating temperature of 200° C.;
or,
a pressure range of the positive pressure air circuit system is 0 bar˜4 bar, and a pressure regulation accuracy of the back pressure control module is greater than or equal to 1 kPa.

10. The micro-nano 3D printing device according to claim 1, wherein:
the signal generator is able to output a variety of waveforms, an output frequency is 0 MHz˜1 MHz, and is able to adjust the output peak voltage, bias voltage, frequency and duty cycle to achieve dot or line printing as needed;
or,
the observation and positioning module comprises one or both of an oblique observation camera and/or a vertical observation camera;
or,
the observation and positioning module uses an industrial camera or a high-resolution CCD camera;
or,
the UV curing module is a UV LED or a high-pressure mercury lamp;
or,
the laser rangefinder measures the distance of transparent or non-transparent materials.
